(19) United States
(12) Patent Application Publication
(10) Pub. No.: US 2026/0036364 A1
(43) Pub. Date: Feb. 5, 2026

(54) CONTROL SYSTEM FOR VESSEL RELIQUEFACTION SYSTEM

(71) Applicant: HANWHA OCEAN CO., LTD., Gyeongsangnam-do (KR)

(72) Inventors: Won Jae CHOI, Seoul (KR); Hyun Jun SHIN, Seoul (KR)

(21) Appl. No.: 19/150,040

(22) PCT Filed: Dec. 29, 2023
(86) PCT No.: PCT/KR2023/021991

§ 371 Date: Jul. 22, 2025

(30) Foreign Application Priority Data
Jan. 27, 2023 (KR) 10-2023-0010969

(51) Int. Cl. F25J 1/02; B63B 25/16; B63J 2/14; F25J 1/00

(52) U.S. Cl. CPC F25J 1/0252; B63B 25/16; B63J 2/14; F25J 1/0025; F25J 1/0072; F25J 1/0208; F25J 2290/70

(57) ABSTRACT

In a control system for a reliquefaction system for ships, boil-off gas generated from liquefied gas in an onboard storage tank is compressed by a compressor and the compressed boil-off gas is cooled and reliquefied through a heat exchanger. The control system includes: a reliquefaction line connecting the compressor to the storage tank; a control valve disposed downstream of the heat exchanger on the reliquefaction line to adjust a flow rate of boil-off gas flowing through the reliquefaction line; a flow rate regulator configured to control a degree of opening of the control valve; and a load controller configured to send a signal for adjusting a load of the reliquefaction system to the flow rate regulator, wherein, in the event of changes in load of the reliquefaction system, the load controller sends a predetermined set point indicative of a boil-off gas flow rate at a corresponding load.

### TECHNICAL FIELD

The present invention relates to a control system for a reliquefaction system for ships, which enables cooling and reliquefaction of boil-off gas (BOG) generated from liquefied gas stored in an onboard storage tank and can rapidly control the reliquefaction system in response to changes in load of the reliquefaction system.

### BACKGROUND ART

Natural gas contains methane as a main component and has been attracting attention as an eco-friendly fuel that emits little or no environmental pollutants during combustion. Liquefied natural gas (LNG) is obtained by liquefying natural gas through cooling to about −163° C. under normal pressure and is suited to long-distance transportation by sea since it has a volume of about 1/600 that of natural gas in a gaseous state. Accordingly, natural gas is stored and transported as liquefied natural gas, which is easy to store and transport.

Since natural gas is liquefied at a cryogenic temperature of −163° C. under normal pressure, LNG storage tanks are typically insulated to maintain LNG in a liquid state. However, despite being insulated, such a storage tank is limited in ability to block external heat. Accordingly, due to external heat continuously transferred to the LNG storage tank, LNG stored in the LNG tank continues to evaporate naturally during transportation, causing generation of boil-off gas (BOG).

Continuous production of boil-off gas in the LNG storage tank increases the internal pressure of the LNG storage tank. If the internal pressure of the storage tank exceeds a predetermined safe pressure, this can cause an emergency situation such as rupture of the storage tank. Accordingly, there is a need to discharge boil-off gas from the storage tank using a safety valve. However, boil-off gas is a kind of LNG loss and is an important issue for transportation efficiency and fuel efficiency of LNG. Therefore, various methods are employed to handle boil-off gas generated in the LNG storage tank.

Recently, a method of using boil-off gas at a fuel demand site such as an engine of a ship, a method of reliquefying boil-off gas and returning the reliquefied boil-off gas to an LNG storage tank, and a method combining these two approaches have been developed and put into use.

### DISCLOSURE

### Technical Problem

Methods for reliquefying boil-off gas include a method that employs a refrigeration cycle using a separate refrigerant to reliquefy boil-off gas through heat exchange with the refrigerant, a method that reliquefies boil-off gas using the boil-off gas itself as a refrigerant without a separate refrigerant, and the like.

As a method of reliquefying boil-off gas using the boil-off gas itself as a refrigerant without a separate refrigerant, a reliquefaction system configured to cool compressed boil-off gas through heat exchange with uncompressed boil-off gas and reliquefy the cooled boil-off gas by adiabatic expansion has been developed and applied to ships.

Systems that utilize a separate refrigeration cycle include, for example, a system that employs a reliquefaction process using nitrogen as a refrigerant.

Despite relative inefficiency compared to a reliquefaction cycle using a mixed refrigerant, such a reliquefaction process using nitrogen refrigerant is safer due to inert properties of the nitrogen refrigerant and is easier to apply to ships since the nitrogen refrigerant does not undergo phase change.

As such, boil-off gas cooled through heat exchange with a separate refrigerant or the boil-off gas itself is introduced into a separator, in which the boil-off gas is separated into gas and liquid phases, and the resulting reliquefied gas is returned to a storage tank.

It is an aspect of the present invention to provide a reliquefaction system which enables effective load adjustment depending on the amount of boil-off gas generated in the storage tank and to be reliquefied, thereby ensuring efficient operation, and a method of operating the same.

### Technical Solution

In accordance with one aspect of the present invention, there is provided a control system for a reliquefaction system for ships, in which boil-off gas generated from liquefied gas in an onboard storage tank is compressed in a compressor and the compressed boil-off gas is cooled and reliquefied through a heat exchanger, the control system including:
a reliquefaction line connecting the compressor to the storage tank.
a control valve disposed downstream of the heat exchanger on the reliquefaction line to adjust a flow rate of boil-off gas flowing through the reliquefaction line;
a flow rate regulator configured to control a degree of opening of the control valve; and
a load controller configured to send a signal for adjusting a load of the reliquefaction system to the flow rate regulator,
wherein, in the event of changes in load of the reliquefaction system, the load controller sends a predetermined set point indicative of a boil-off gas flow rate at a corresponding load to the flow rate regulator to adjust the load of the reliquefaction system.

Preferably, the control system further includes: a temperature regulator configured to detect a temperature of the compressed boil-off gas downstream of the heat exchanger on the reliquefaction line and to send an adjustment value for fine adjustment of the load of the reliquefaction system; and a calculation unit configured to receive the predetermined set point from the load controller and the adjustment value from the temperature regulator and to send an adjusted set point for regulating the degree of opening of the control valve to the flow rate regulator.

Preferably, the control system further includes: a flow meter disposed upstream of the heat exchanger on the reliquefaction line to detect a flow rate of boil-off gas introduced into the heat exchanger and to send the detected data to the flow rate regulator; and a temperature detector configured to detect the temperature of the compressed boil-off gas downstream of the heat exchanger on the reliquefaction line and to send the detected data to the temperature regulator.

Preferably, in the event of changes in load of the reliquefaction system, the flow rate regulator and the temperature regulator are operated in a master-slave mode to enhance responsiveness to load changes.

Preferably, the reliquefaction system further includes a refrigerant circulation system including: a refrigerant circulation line through which a refrigerant exchanging heat with the compressed boil-off gas in the heat exchanger is circulated; a refrigerant expander configured to expand and cool the refrigerant to be supplied to the heat exchanger; and a refrigerant compressor configured to compress the refrigerant discharged from the heat exchanger after undergoing heat exchange.

Preferably, the refrigerant circulating through the refrigerant circulation system is nitrogen and, in the event of changes in load of the reliquefaction system, a mass flow rate of the refrigerant is adjusted by discharging some refrigerant from the refrigerant circulation system or adding more refrigerant to the refrigerant circulation system to adjust the amount of cold heat supplied to the reliquefaction system.

Preferably, the boil-off gas cooled through the heat exchanger is subjected to gas-liquid separation in a separator, the separated liquefied gas is supplied to the storage tank, and flash gas separated in the separator is joined with boil-off gas to be introduced into the compressor and is supplied to the compressor after undergoing cold heat recovery in the heat exchanger.

### Advantageous Effects

The control system according to the present invention enables more effective cooling of boil-off gas to be reliquefied by utilizing both cold heat of the boil-off gas itself and cold heat in a refrigerant cycle, thereby providing an enhanced reliquefaction rate.

In the event of changes in load of a reliquefaction system due to changes in the amount of boil-off gas generated in a storage tank and to be reliquefied, the control system according to the present can rapidly adjust the load of the reliquefaction system through adjustment of the flow rate of boil-off gas introduced into a heat exchanger.

### DESCRIPTION OF DRAWINGS

FIG. 1 is a schematic diagram of a control system for a reliquefaction system for ships according to one embodiment of the present invention.

FIG. 2 is a graph depicting changes in boil-off gas flow rate depending on the load of the reliquefaction system, as controlled by the control system according to the present invention.

FIG. 3 is a more detailed diagram of the control system for the reliquefaction system illustrated in FIG. 1.

### EMBODIMENTS

In order to fully appreciate the operational advantages of the present invention and the objectives achieved by practicing the present invention, reference should be made to the accompanying drawings, which illustrate preferred embodiments of the present invention, and description thereof.

Hereinafter, exemplary embodiments of the present invention will be described in detail in terms of the features and effects thereof with reference to the accompanying drawings. It should be noted that like components will be denoted by like reference numerals throughout the specification and the accompanying drawings.

As used herein, the term “ship” may refer to any type of ship that is provided with a liquefied gas storage tank. For example, the ship may include self-propelled vessels, such as an LNG carrier, a liquid hydrogen carrier, and an LNG regasification vessel (RV), as well as non-self-propelled floating offshore structures, such as an LNG floating production storage and offloading (FPSO) unit and an LNG floating storage regasification unit (FSRU).

In addition, the embodiments of the present invention may be applied to a reliquefaction cycle for any type of liquefied gas that can be transported in a liquid state by liquefaction at cryogenic temperatures and can generate boil-off gas during storage. For example, such liquefied gas may include liquefied petrochemical gas, such as liquefied natural gas (LNG), liquefied ethane gas (LEG), liquefied petroleum gas (LPG), liquefied ethylene gas, and liquefied propylene gas. In the following embodiments, the present invention will be described using LPG, which is a typical liquefied gas, as an example.

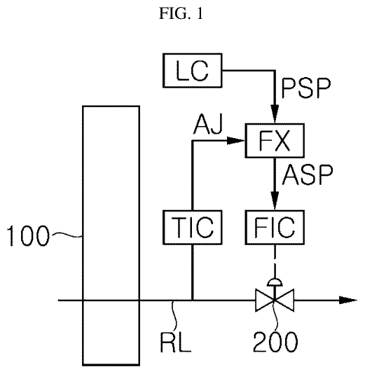

FIG. 1 is a schematic diagram of a control system for a reliquefaction system for ships according to one embodiment of the present invention.

Referring to FIG. 1, the control system according to this embodiment is used in a reliquefaction system for ships, in which boil-off gas generated from liquefied gas in an onboard storage tank (not shown) is compressed by a compressor, cooled and reliquefied by a heat exchanger, and returned to the storage tank, to rapidly adjust the load of the reliquefaction system in response to changes in load thereof.

The reliquefaction system includes a compressor (not shown) configured to receive and compress boil-off gas, a boil-off gas supply line (not shown) through which boil-off gas from the storage tank is supplied to the compressor, and a reliquefaction line (RL) connecting the compressor to the storage tank and allowing boil-off gas to be reliquefied and returned to the storage tank therealong.

The boil-off gas supply line extends from the storage tank to the compressor through a heat exchanger 100 such that uncompressed boil-off gas from the storage tank is supplied to the compressor for compression after supplying cold heat to the heat exchanger.

The compressor (not shown) may compress the boil-off gas to a certain pressure, for example, to a fuel supply pressure required for a main engine of a ship. For example, the compressor may compress the boil-off gas to a pressure of about 5.5 barg for DF engines, about 15 barg for X-DF engines, and about 300 barg for ME-GI engines. The compressed boil-off gas may be supplied as fuel to a demand site, such as the main engine (not shown) of the ship, and surplus boil-off gas may be reliquefied through the reliquefaction system along the reliquefaction line RL.

The compressed boil-off gas from the compressor is introduced into the heat exchanger 100 along the reliquefaction line RL to be cooled through heat exchange, the cooled boil-off gas is subjected to gas-liquid separation in a separator (not shown), and the separated reliquefied gas is returned to the storage tank.

In the heat exchanger 100, the boil-off gas is cooled by both a refrigerant circulating through a refrigerant circulation system and cold heat of uncompressed boil-off gas to be introduced into the compressor.

The refrigerant circulation system (not shown) includes a refrigerant circulation line (not shown) through which a refrigerant circulates, wherein the refrigerant circulation line may be provided with a refrigerant expander (not shown) configured to expand and cool the refrigerant to be supplied to the heat exchanger, a refrigerant compressor (not shown) configured to compress the refrigerant discharged from the heat exchanger, and a motor configured to drive the refrigerant compressor. The refrigerant compressor and the refrigerant expander may be connected to each other through a common shaft to use expansion energy of the refrigerant for compression of the refrigerant in the refrigerant compressor, thereby reducing power consumption required to operate a refrigerant cycle.

For example, nitrogen (N₂) may be used as the refrigerant circulating through the refrigerant circulation line to supply cold heat to the heat exchanger. The amount of cold heat delivered to the heat exchanger may be adjusted by adding more nitrogen refrigerant to the circulation line from a refrigerant inventory system (not shown) or by discharging some refrigerant from the circulation line.

The compressed refrigerant from the refrigerant compressor is cooled by the heat exchanger 100, expanded and cooled by the refrigerant expander, and supplied as a refrigerant to the heat exchanger 100 while circulating through the refrigerant circulation line. Accordingly, in the heat exchanger 100, four streams including a stream of boil-off gas compressed by the compressor and to be reliquefied, a stream of uncompressed boil-off gas to be introduced into the compressor, a stream of the refrigerant expanded and cooled by the refrigerant expander, and a stream of the refrigerant compressed by the refrigerant compressor undergo heat exchange.

The cooled boil-off gas from the heat exchanger may be subjected to gas-liquid separation in a separator (not shown) after passing through a control valve 200 disposed downstream of the heat exchanger. Then, the separated reliquefied gas from the separator (not shown) may be supplied to the storage tank for re-storage and the resulting flash gas may be joined with the stream of uncompressed boil-off gas upstream of the heat exchanger on the boil-off gas supply line or may be delivered to a gas combustion unit (GCU).

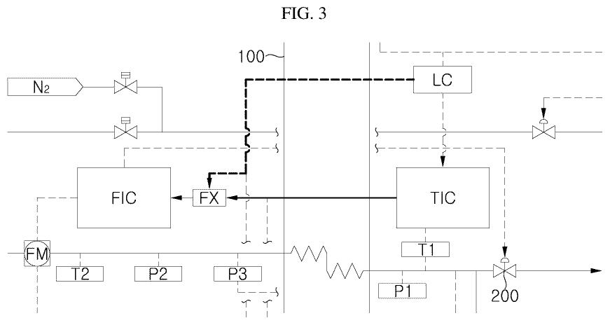

Changes in the amount of boil-off gas generated in the storage tank, the amount of boil-off gas consumed as fuel for an engine and the like, or the composition of boil-off gas lead to changes in the amount of cold heat required for the reliquefaction system, thus requiring adjustment of the load of the reliquefaction system. FIG. 1 is a schematic diagram of a control system for a reliquefaction system for ships according to one embodiment and FIG. 3 is a more detailed diagram of the control system of FIG. 1.

The control system according to this embodiment is used to adjust the load of the reliquefaction system and includes: a control valve 200 disposed downstream of the heat exchanger 100 to adjust the flow rate of boil-off gas flowing through the reliquefaction line; a flow rate regulator FIC configured to control the degree of opening of the control valve; and a load controller LC configured to send a signal for adjusting the load of the reliquefaction system to the flow rate regulator, as shown in FIG. 1 and FIG. 3.

In addition, the control system includes: a temperature regulator TIC configured to detect the temperature of the compressed boil-off gas downstream of the heat exchanger on the reliquefaction line and to send an adjustment value for fine adjustment of the load of the reliquefaction system; and a calculation unit FX configured to receive a predetermined set point from the load controller and the adjustment value from the temperature regulator and to send an adjusted set point for regulating the degree of opening of the control valve to the flow rate regulator.

The reliquefaction line RL is provided with: a flow meter FM disposed upstream of the heat exchanger 100 to detect the flow rate of boil-off gas introduced into the heat exchanger 100 and to send the detected data to the flow rate regulator; and a temperature detector Tl disposed downstream of the heat exchanger 100 to detect the temperature of the compressed boil-off gas downstream of the heat exchanger on the reliquefaction line and to send the detected data to the temperature regulator.

In this embodiment, in the event of changes in load of the reliquefaction system, the load controller LC sends a predetermined set point indicative of a flow rate of boil-off gas at a corresponding load to the flow rate regulator FIC to adjust the load of the reliquefaction system.

In a reliquefaction system using nitrogen as a refrigerant, load adjustment of the system is primarily performed through adjustment of the amount of cold heat in a nitrogen (N₂) refrigerant cycle and is secondarily performed through control of the temperature of boil-off gas to be reliquefied to achieve load balancing of the system. However, relying solely on temperature control has limitations in responsiveness to load changes, potentially resulting in energy imbalances that can cause destabilization of the reliquefaction process and even emergency shutdown.

To solve this problem, in this embodiment, in the event of changes in load of the reliquefaction system, the load of the reliquefaction system is adjusted through regulation of the flow rate of boil-off gas and, furthermore, the flow rate regulator and the temperature regulator are operated in a master-slave mode to ensure improved responsiveness to load changes and improved control accuracy.

That is, in the event of changes in load of the reliquefaction system, primary load adjustment may be performed by regulating the amount of cold heat supplied to the reliquefaction system through adjustment of a mass flow rate of the refrigerant in the refrigerant circulation line, which may be achieved by discharging some refrigerant from the refrigerant circulation system or by adding more refrigerant to the refrigerant circulation line. Secondarily, the load controller LC sends a predetermined set point PSP, as calculated using actual test data for the flow rate of boil-off gas at a corresponding load, to the flow rate regulator FIC, which, in turn, regulates the degree of opening of the control valve 200 based on the predetermined set point to adjust the flow rate of boil-off gas introduced into the heat exchanger along the reliquefaction line. The temperature detector Tl detects the temperature of the compressed boil-off gas downstream of the heat exchanger and the temperature regulator TIC sends an adjustment value AJ for fine load adjustment based on the detected temperature of the compressed boil-off gas downstream of the heat exchanger. The calculation unit FX calculates an adjusted set point ASP by applying the adjustment value received from the temperature regulator to the predetermined set point received from the load controller and sends the calculated adjusted set point to the flow rate regulator. Then, the flow rate regulator regulates the degree of opening of the control valve based on the received adjusted set point to adjust the flow rate of boil-off gas introduced into the heat exchanger, thereby achieving load balancing of the reliquefaction system.

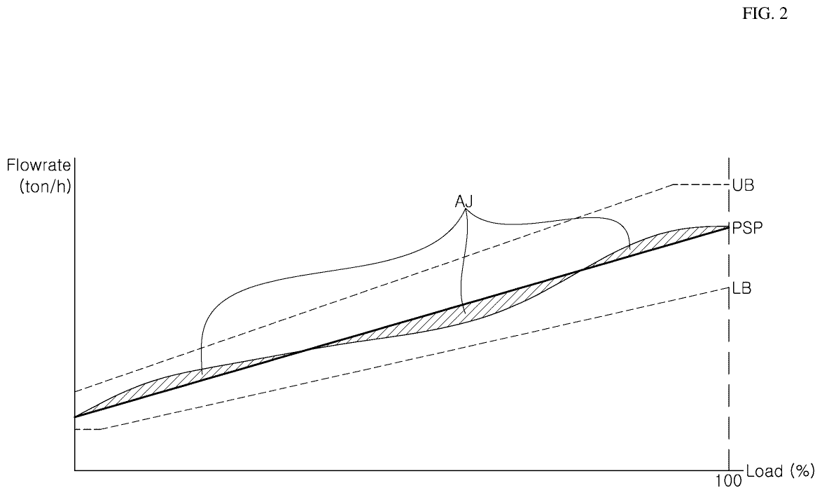

FIG. 2 is a graph depicting changes in flow rate (ton/h) of boil-off gas in response to changes in load (%) of the reliquefaction system under the control system according to this embodiment. In the graph, the top dotted line UB represents an upper boundary of the load-dependent flow rate of boil-off gas and the bottom dotted line LB represents a lower boundary of the load-dependent flow rate of boil-off gas. The bold straight line PSP represents changes in flow rate of boil-off gas depending on changes in load of the reliquefaction system, as calculated using actual load test data. A flow rate of boil-off gas at a corresponding load in the bold straight line is transmitted as the predetermined set point from the load controller to the flow rate regulator. The hatched area AJ represents an adjustment value transmitted by the temperature regulator based on the temperature of boil-off gas downstream of the heat exchanger.

It was confirmed that load adjustment using the master-slave method as in this embodiment can improve the control speed by 35% or more compared to load adjustment using the temperature control method alone, demonstrating significant improvement in responsiveness.

Furthermore, given that the amount of boil-off gas reliquefied varies depending on the composition of the boil-off gas even when the amount of cold heat supplied to the reliquefaction system remains constant, the control system according to this embodiment performs load adjustment through adjustment of the flow rate of boil-off gas and then performs correction through the temperature regulator, thereby ensuring improved control accuracy and thus stable operation of the reliquefaction system.

Although some embodiments have been described, it will be apparent to those skilled in the art that these embodiments are given by way of illustration only, and that various modifications, changes, alterations, and equivalent embodiments can be made without departing from the spirit and scope of the invention.

1. A control system for a reliquefaction system for ships, in which boil-off gas generated from liquefied gas in an onboard storage tank is compressed by a compressor and is cooled and reliquefied through a heat exchanger, the control system comprising:
a reliquefaction line connecting the compressor to the storage tank.
a control valve disposed downstream of the heat exchanger on the reliquefaction line to adjust a flow rate of boil-off gas flowing through the reliquefaction line;
a flow rate regulator configured to control a degree of opening of the control valve; and
a load controller configured to send a signal for adjusting a load of the reliquefaction system to the flow rate regulator,
wherein, in the event of changes in load of the reliquefaction system, the load controller sends a predetermined set point indicative of a boil-off gas flow rate at a corresponding load to the flow rate regulator to adjust the load of the reliquefaction system.

2. The control system according to claim 1, further comprising:
a temperature regulator configured to detect a temperature of the compressed boil-off gas downstream of the heat exchanger on the reliquefaction line and to send an adjustment value for fine adjustment of the load of the reliquefaction system; and
a calculation unit configured to receive the predetermined set point from the load controller and the adjustment value from the temperature regulator and to send an adjusted set point for regulating the degree of opening of the control valve to the flow rate regulator.

3. The control system according to claim 2, further comprising:
a flow meter disposed upstream of the heat exchanger on the reliquefaction line to detect a flow rate of boil-off gas introduced into the heat exchanger and to send the detected data to the flow rate regulator; and
a temperature detector configured to detect the temperature of the compressed boil-off gas downstream of the heat exchanger on the reliquefaction line and to send the detected data to the temperature regulator.

4. The control system according to claim 3, wherein, in the event of changes in load of the reliquefaction system, the flow rate regulator and the temperature regulator are operated in a master-slave mode to enhance responsiveness to load changes.

5. The control system according to claim 3, wherein the reliquefaction system further comprises a refrigerant circulation system comprising: a refrigerant circulation line through which a refrigerant exchanging heat with the compressed boil-off gas in the heat exchanger is circulated; a refrigerant expander configured to expand and cool the refrigerant to be supplied to the heat exchanger; and a refrigerant compressor configured to compress the refrigerant discharged from the heat exchanger after undergoing heat exchange.

6. The control system according to claim 5, wherein
the refrigerant circulating through the refrigerant circulation system is nitrogen, and,
in the event of changes in load of the reliquefaction system, a mass flow rate of the refrigerant is adjusted by discharging some refrigerant from the refrigerant circulation system or adding more refrigerant to the refrigerant circulation system to adjust the amount of cold heat supplied to the reliquefaction system.

7. The control system according to claim 1, wherein the boil-off gas cooled through the heat exchanger is subjected to gas-liquid separation in a separator, the separated liquefied gas is supplied to the storage tank, and flash gas separated in the separator is joined with the boil-off gas to be introduced into the compressor and is supplied to the compressor after undergoing cold heat recovery in the heat exchanger.
